(19) United States
(12) Patent Application Publication
(10) Pub. No.: US 2010/0079394 A1
(43) Pub. Date: Apr. 1, 2010

(54) INPUT DEVICE AND DISPLAY

(75) Inventors: Tsutomu Tanaka, Kanagawa (JP); Hiroshi Mizuhashi, Kanagawa (JP)

Correspondence Address: ROBERT J. DEPKE;LEWIS T. STEADMAN, ROCKEY, DEPKE & LYONS, LLC, SUITE 5450 SEARS TOWER, CHICAGO, IL, 60606-6306, US

(73) Assignee: Sony Corporation, Tokyo (JP)

(21) Appl. No.: 12/557,289

(22) Filed: Sep. 10, 2009

(30) Foreign Application Priority Data
Oct. 1, 2008 (JP) 2008-256060

(51) Int. Cl. G06F 3/041; G09G 5/00

(52) U.S. Cl. 345/173; 345/156

(57) ABSTRACT

An input device and a display allowing latency to be reduced without degradation in display performance are provided. An input device includes a panel including: a plurality of sensor devices two-dimensionally arranged in row and column directions, a drive circuit driving the plurality of sensor devices, and a processing circuit processing output signals from the plurality of sensor devices, in which the processing circuit, prior to taking in all of the output signals from the plurality of sensor devices, determines whether or not one or more ON signals, defined as output signals affected by an object which touches or comes close to a surface of the panel, are included in previously inputted output signals, and then outputs a determination result.

### BACKGROUND OF THE INVENTION

1. Field of the Invention

The present invention relates to an input device and a display having an input function for reading, for example, information or image information on an object (an object to be detected) touching or coming close to a surface thereof, or reading information on a fingerprint or veins of a finger touching the surface.

2. Description of the Related Art

In recent years, flat-type displays such as liquid crystal displays or organic EL displays are becoming more multifunctional, and as described in Japanese Unexamined Patent Application Publication No. 2001-075074, there is proposed a flat-type display having a typical image display function as well as an input function of reading touch information or image information on an object touching a display surface thereof or reading information on a fingerprint or veins of a finger touching the display surface by arranging a sensor device adjacent to a display pixel.

### SUMMARY OF THE INVENTION

However, in related art, the above-described information is obtained by processing an output signal from a sensor device in an external processing circuit arranged separately from an I/O panel. Therefore, it is necessary for a processing circuit in the following stage of the external processing circuit, for example, a circuit which executes arithmetic processing using information derived from a processing circuit located in the previous state, to wait to start arithmetic processing until an output result is obtained from the external processing circuit. Thereby, there is an issue that a time (latency) from when an object touches a display surface to when the execution of arithmetic processing starts is increased.

For example, in the case where it takes 1/60 seconds (16 ms) to output an image of 1 frame by scanning selection lines, it takes 16 ms at maximum from when an object touches a display surface to when a sensor device detects the touch of the object. Moreover, it takes approximately 5 ms from when the sensor device detects the touch of the object to when the above-described processing circuit following the external processing circuit starts arithmetic processing. Therefore, in this case, a latency of approximately 21 ms at maximum occurs.

Moreover, in some cases, a processing circuit which starts arithmetic processing in response to the reception of some signal is designed to sleep until the signal is inputted in terms of a reduction in power consumption and wake up (restart) in response to the input of the signal as a trigger. In such a case, a longer latency than that in the above-described case occurs.

Therefore, for example, it is considered that the scan speed for scanning selection lines is increased. However, in such a case, it is necessary to arrange a signal line or a scanning line for detection, thereby a decline in image quality such as a reduction in display aperture ratio or disordered display caused by an output signal from a sensor device is caused.

It is desirable to provide an input device and a display allowing latency to be reduced without degradation in display performance.

According to an embodiment of the invention, there is provided an input device including a panel including: a plurality of sensor devices two-dimensionally arranged in row and column directions, a drive circuit driving the plurality of sensor devices, and a processing circuit processing output signals from the plurality of sensor devices. The above-described processing circuit, prior to taking in all of the output signals from the plurality of sensor devices, determines whether or not one or more ON signals are included in previously inputted output signals, and then outputs a determination result. In addition, the above-described ON signals are defined as output signals affected by an object which touches or comes close to a surface of the panel.

According to an embodiment of the invention, there is provided a display including a panel including: a plurality of display pixels and a plurality of sensor devices two-dimensionally arranged in row and column directions, a drive circuit driving the plurality of display pixels and the plurality of sensor devices, and the above-described processing circuit.

In the input device and the display according to the embodiment of the invention, in the processing circuit arranged in the panel, prior to taking in all of the output signals from all of sensor devices, determination information is outputted. Thereby, for example, before signals obtained from output signals from all sensor devices are inputted into the external processing section provided separately from the panel, the determination information is allowed to be inputted into the external processing section. Thereby, latency is allowed to be reduced.

Other and further objects, features and advantages of the invention will appear more fully from the following description.

### BRIEF DESCRIPTION OF THE DRAWINGS

FIG. 1 is a block diagram of the whole configuration of a display according to a first embodiment of the invention.

FIG. 2 is a block diagram of an example of an internal configuration of a touch detection circuit in FIG. 1.

FIG. 3 is a schematic view for describing operation of the touch detection circuit in FIG. 1.

FIG. 4 is a timing chart for describing operation of the touch detection circuit in FIG. 1.

FIG. 5 is a block diagram of a modification of the touch detection circuit in FIG. 2.

FIG. 6 is a schematic view for describing operation of the touch detection circuit in FIG. 5.

FIG. 7 is a timing chart for describing operation of the touch detection circuit in FIG. 5.

FIG. 8 is a schematic view for describing operation of another modification of the touch detection circuit in FIG. 1.

FIG. 9 is a block diagram of the whole configuration of a display according to a second embodiment of the invention.

FIG. 10 is a block diagram of an example of an internal configuration of a touch detection circuit in FIG. 9.

FIG. 11 is a schematic view for describing operation of the touch detection circuit in FIG. 9.

### DETAILED DESCRIPTION OF THE PREFERRED EMBODIMENTS

Preferred embodiments will be described in detail below referring to the accompanying drawings.

### First Embodiment

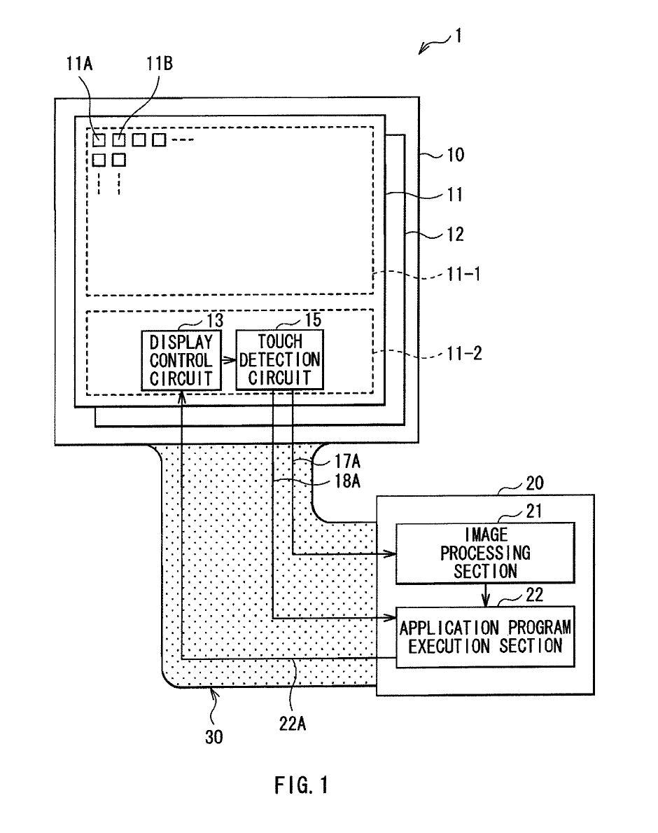

FIG. 1 illustrates the whole configuration of a display 1 according to a first embodiment of the invention. The display 1 according to the embodiment is a display having an input function of reading touch information on an object (an object to be detected) touching a surface thereof. The display 1 includes a display section 10, an external processing section 20 arranged separately from the display section 10, and a signal transmission section 30 transmitting signals between the display section 10 and the external processing section 20. An input device according to an embodiment of the invention is embodied by the above-described display 1, so the input device will be also described below.

The display section 10 includes an I/O panel 11 (panel) and a backlight 12. In the I/O panel 11, a plurality of display pixels 11A and a plurality of sensor devices 11B are two-dimensionally arranged in row and column directions in one plane. The I/O panel 11 functions as an input/output device which outputs image information through the display pixels 11A, and receives the input of information from outside through the sensor devices 11B. The backlight 12 is, for example, a surface-emitting light source emitting light in a visible region to a back surface of the I/O panel 11. The backlight 12 includes, for example, a cold cathode fluorescent lamp (CCFL), a light emitting diode (LED) or the like.

The display pixels 11A modulate incident light from the backlight 12 according to the magnitude of a voltage applied from a display control circuit 13 which will be described later to output the modulated light. The display pixels 11A each include, for example, a red light emitting cell which emits red light, a green light emitting cell which emits green light and a blue light emitting cell which emits blue light. Each light emitting cell corresponds to a part corresponding to each pixel electrode in a liquid crystal display panel formed by arranging a liquid crystal layer between a transparent substrate on an image display side which includes pixel electrodes arranged in a matrix form and a transparent substrate on a backlight side which includes a solidly formed common electrode.

On the other hand, the sensor devices 11B each are, for example, a contact type sensor including a pair of electrodes opposed to each other with a space in between, and detect the touch of an object on a surface by the contact of the pair of electrodes with each other. For example, the sensor devices 11B are formed together with the pixel electrodes on the transparent substrate, TFTs (Thin Film Transistors) driving the pixel electrodes, the common electrode and the like in the above-described liquid crystal display panel.

The I/O panel 11 further includes the display control circuit 13 (a drive circuit) and a touch detection circuit 15 (a processing circuit). For example, the display control circuit 13 and the touch detection circuit 15 are formed in a region where the sensor devices 11B, TFTs and the like are not formed on a surface of the transparent substrate on the image display side in the above-described liquid crystal display panel. In other words, the I/O panel 11 includes a pixel region 11-1 where the display pixels 11A and the sensor devices 11B are formed and a circuit region 11-2 where the display control circuit 13 and the touch detection circuit 15 are formed.

In addition, in the case where the display control circuit 13 and the touch detection circuit 15 are formed together with the sensor devices 11B, the TFTs and the like on the surface of the transparent substrate on the image display side, they are preferably integrated. In such a case, not only a reduction in power consumption but also a reduction in resistance in wiring connecting between circuits or a reduction in signal waveform distortion is achieved. Moreover, the number of output terminals is reduced, so in such a case, reliability is improved. Further, the touch detection circuit 15 is insusceptible to noises, so more reliable sensing is achieved.

The display control circuit 13 drives the plurality of display pixels 11A to display an image on the pixel region 11-1. The display control circuit 13 includes, for example, a display signal generation section, a display signal storage control section, a display signal driver, a scanner for display and the like (all not illustrated).

The display signal generation section generates a display signal for displaying an image for, for example, each screen (each field of display) on the display section 10 based on image data 22A supplied from an application program execution section 22. The display signal generated in such a manner is outputted to the display signal storage control section.

The display signal storage control section stores and keeps the display signal outputted from the display signal generation section for each screen in, for example, a field memory including an SRAM (Static Random Access Memory) or the like. The display signal storage control section also plays a role in controlling the display signal driver driving each display pixel 11A, the scanner for display and the touch detection circuit 15 to operate simultaneously with each other.

The display signal driver supplies a voltage corresponding to display data for one horizontal line outputted from the display signal storage control section to a display pixel 11A to be driven. More specifically, the display signal driver drives the display pixel 11A to be driven by supplying the voltage corresponding to the display data for one horizontal line to a signal line (not illustrated) connecting between the display signal driver and each display pixel 11A in response to a control signal outputted from the display signal storage control section.

The scanner for display selects the display pixel 11A to be driven in response to the control signal outputted from the display signal storage control section. More specifically, the scanner for display selects the display pixel 11A to be driven by successively supplying a scan signal to a scanning line (not illustrated) connecting between the scanner for display and each display pixel 11A.

The touch detection circuit 15 extracts element information (which will be described later) on the object to be detected from output signals 11C outputted from a plurality of sensor devices 11B by detection scanning performed at predetermined periods corresponding to, for example, display scanning for one screen, and derives serial data (which will be described later) used for specifying the position or touch area of the object to be detected.

In this case, the element information indicates basic information which is necessary to obtain information such as the position or touch area of the object to be detected. For example, in the case where an output signal affected by the object to be detected indicates an ON signal, the above-described element information includes determination information that whether or not an output signal corresponding to the ON signal is present in the output signals 11C inputted from the sensor devices 11B.

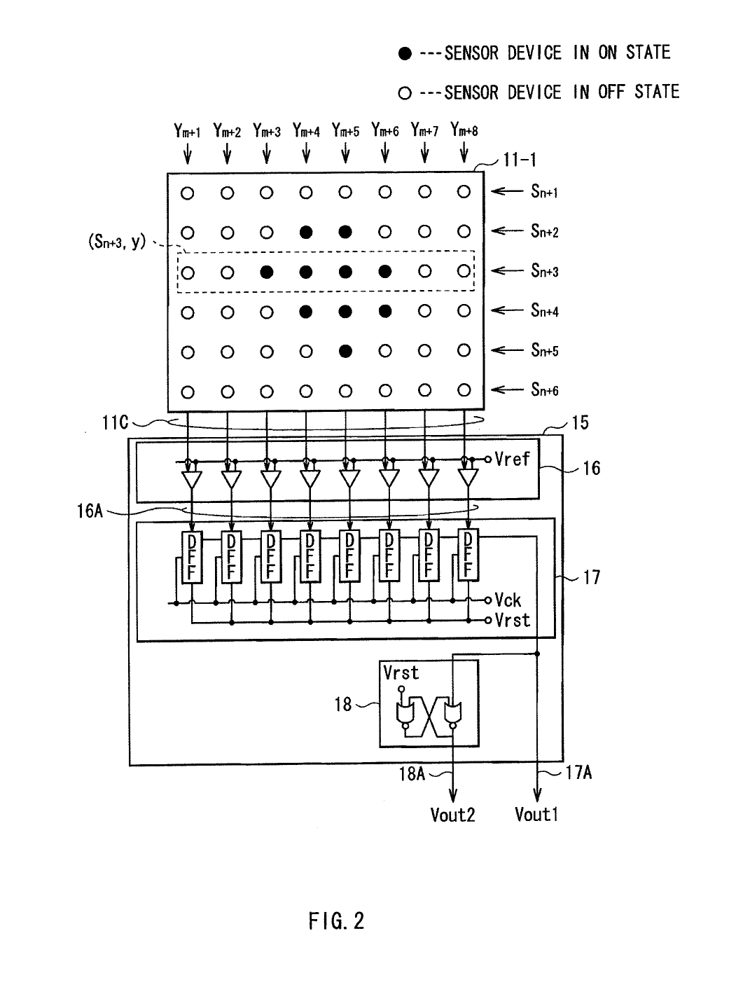

In FIG. 2, a sensor device 11B in an ON state which outputs the ON signal as the output signal 11C is indicated by a black circle, and a sensor device 11B in an OFF state which outputs an OFF signal (an output signal not affected by the object to be detected) as the output signal 11C is indicated by a white circle. Moreover, in FIG. 2, to indicate the positions on the pixel region 11-1 of the sensor devices 11B two-dimensionally arranged in row and column directions, positions in the column direction are indicated by Yₘ₊₁, Yₘ₊₂, Yₘ₊₃, Yₘ₊₄, Yₘ₊₅, Yₘ₊₆, Yₘ₊₇, and Yₘ₊₈ (m is a positive value of 1 or more), and positions in the row direction are indicated by Sₙ₊₁, Sₙ₊₂, Sₙ₊₃, Sₙ₊₄, Sₙ₊₅, and Sₙ₊₆ (n is a positive value of 1 or more).

For example, as illustrated in FIG. 2, the touch detection circuit 15 includes a conversion circuit 16, a parallel-in serial-out circuit 17 and a determination circuit 18.

The conversion circuit 16 is an analog-digital conversion circuit binarizing the output signals 11C outputted from the sensor devices 11B. For example, the conversion circuit 16 converts an output signal 11C corresponding to the ON signal into a signal corresponding to “1”, and converts an output signal 11C corresponding to the OFF signal into a signal corresponding to “0”. For example, as exemplified in FIG. 2, binarization is performed by the following steps. The output signal 11C and a reference potential V_{ref} are inputted into a comparator (indicated by an triangle in the drawing), and in the case where the output signal 11C is larger than the reference potential V_{ref}, the signal corresponding to “1” is outputted as an output signal 16A, and in the case where the output signal 11C is equal to or lower than the reference potential V_{ref}, the signal corresponding to “0” is outputted as the output signal 16A, thereby binarization is performed. In the conversion circuit 16, for example, as illustrated in FIG. 2, the output signals 11C inputted in parallel from the sensor devices 11B are converted into the output signals 16A, and the output signals 16A are outputted in parallel.

The parallel-in serial-out circuit 17 is a circuit converting the group of output signals 16A outputted in parallel from the conversion circuit 16 into serial signals (serial data), and outputs the serial data. For example, as illustrated in FIG. 2, such a circuit is formed by the following steps. A plurality of DFFs (Delay Flip-Flops) are prepared, and one input of one DFF is connected to an output of another DFF, and the other input of each DFF is separately connected to each output terminal of the conversion circuit 16. Then, a common clock line (V_{ck}) is connected to a clock terminal of each DFF, and a common reset line (Vᵣₛₜ) is connected to a reset terminal of each DFF, thereby the circuit is formed. In the circuit, the output signals 16A are outputted one by one sequentially (that is, in series) from the DFF located at the last stage as output signals 17A. In addition, in the embodiment, the output signals 17A are outputted to the external processing section 20 arranged separately from the display section 10.

The determination circuit 18 determines whether or not an output signal corresponding to the ON signal is included in the output signals 17A sequentially inputted from the parallel-in serial-out circuit 17. For example, as illustrated in FIG. 2, the determination circuit 18 includes an OR circuit determining whether or not any one of two temporally adjacent output signals 17A in the output signals 17A sequentially inputted from the parallel-in serial-out circuit 17 corresponds to the ON signal.

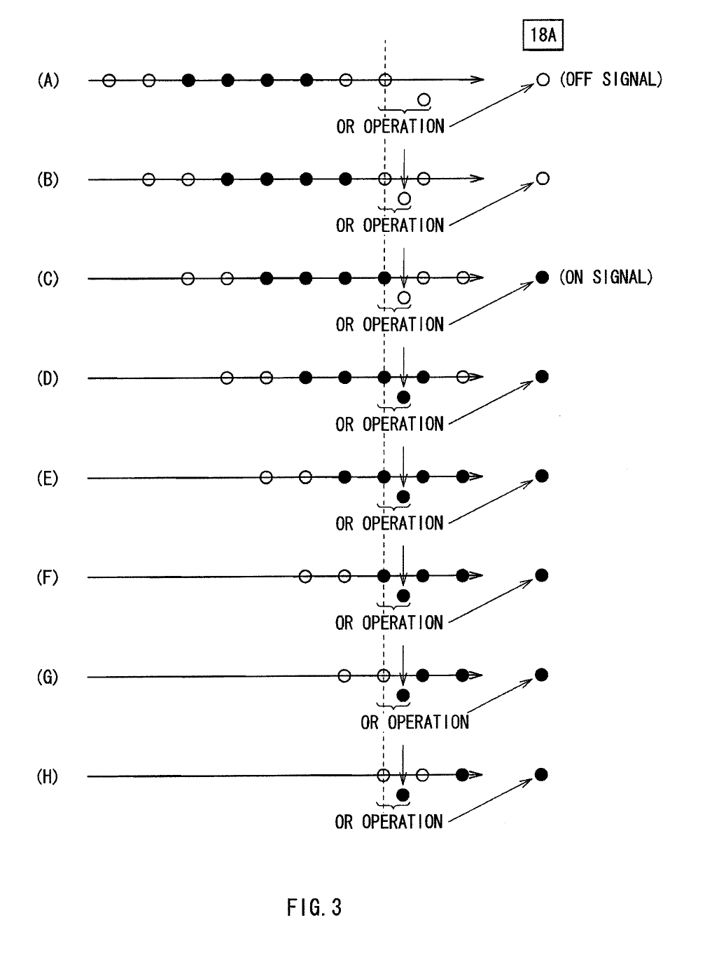

A determination method with the OR circuit will be described below referring to schematic views illustrated in FIGS. 3(A) to 3(H). First, an OR operation is performed on an output signal 17A (a white circle positioned on a broken line of FIG. 3(A)) inputted from the sensor device 11B in the rightmost position in a group of output signals 17A (for example, output signals 17A from the sensor devices 11B in a row (Sₙ₊₃, y) in FIG. 2) and a signal prepared as an initial value (a white circle located in a position deviated from a horizontal axis in FIG. 3(A)). In this case, both signals are correspond to white circles, that is, OFF signals, so the determination circuit 18 outputs a signal corresponding to an OFF signal as an output signal 18A.

Next, an OR operation is performed on an output signal 17A (a white circle located on a broken line in FIG. 3(B)) inputted from the second sensor device 11B from the right in the group of output signals 17A (for example, the output signals 17A from the sensor devices 11B in the row (Sₙ₊₃, y) in FIG. 2) and the signal (a white circle located in a position deviated from a horizontal axis in FIG. 3(B)) outputted from the determination circuit 18 by the previous OR operation. In this case, both signals correspond to white circles, that is, OFF signals, so the determination circuit 18 outputs a signal corresponding to an OFF signal as an output signal 18A.

Next, an OR operation is performed on an output signal 17A (a black circle located on a broken line in FIG. 3(C)) inputted from the third sensor device 11B from the right in the group of output signals 17A (for example, the output signals 17A from the sensor devices 11B in the row (Sₙ₊₃, y) in FIG. 2) and the signal (a white circle located in a position deviated from a horizontal axis in FIG. 3(C)) outputted from the determination circuit 18 by the previous OR operation. In this case, one of the signals corresponds to a black circle, that is, an ON signal, so the determination circuit 18 outputs a signal corresponding to an ON signal as an output signal 18A.

After that, the determination circuit 18 further performs OR operations as illustrated in FIGS. 3(D) to 3(H) in the same manner, and outputs a signal corresponding to a result of each OR operation as an output signal 18A.

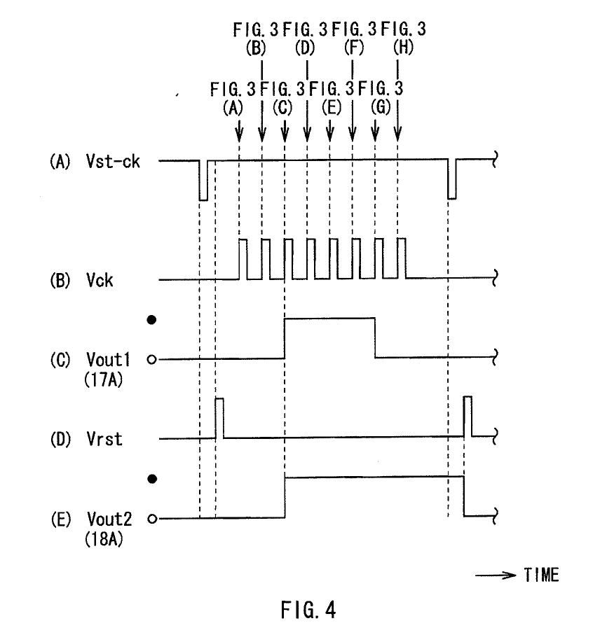

Further, the above-described OR operation will be described with waveform diagrams in FIGS. 4(A) to 4(E). In this case, a waveform V_{st-ck} in FIG. 4(A) indicates a read start trigger for the output signal 11C in the touch detection circuit 15, and corresponds to, for example, a control signal or the like inputted from the display control circuit 13 to the touch detection circuit 15. Moreover, a waveform V_{ck} in FIG. 4(B) indicates a clock signal inputted from the clock line connected to the above-described DFFs to the DFFs. A waveform Vₒᵤₜ, in FIG. 4(C) indicates the voltage of the output signal 17A. A waveform Vᵣₛₜ in FIG. 4(D) indicates a reset signal inputted from the reset line connected to the above-described DFFs to the DFFs. In addition, the reset signal inputted into the DFFs is inputted into the determination circuit 18 at the same time (refer to FIG. 2). A waveform Vₒᵤₜ₂ in FIG. 4(E) indicates the voltage of the output signal 18A.

It is obvious from FIG. 4(B) that the determination circuit 18 performs an OR operation schematically illustrated in FIGS. 3(A) to 3(G) at a rising edge of the waveform V_{ck} to change the output signals 17A and 18A according to the result of the OR operation. According to the nature of OR operation, once the output signal 18A has a voltage corresponding to the ON signal, even if any other output signal 17A is subsequently inputted into the determination circuit 18, the determination circuit 18 outputs a voltage corresponding to the ON signal as the output signal 18A. Therefore, it is necessary to input a reset signal into the determination circuit 18 before another group of output signals 17A is newly inputted into the determination circuit 18, thereby to allow the output signal 18A to be set to a voltage corresponding to the OFF signal.

Thus, the touch detection circuit 15, prior to taking in all of the output signals 11C from the plurality of sensor devices 11B, determines whether or not the ON signal is included in previously inputted output signals 11C, and outputs a determination result as the output signal 18A. Moreover, the touch detection circuit 15 outputs a determination result as the output signal 18A whenever each of the output signals 17A obtained from the output signals 11C from one row of sensor devices 11B in the plurality of sensor devices 11B is inputted in series.

The external processing section 20 illustrated in FIG. 1 includes an image processing section 21 and an application program execution section 22.

The image processing section 21 performs predetermined signal processing on the output signals 17A (serial data) inputted from the touch detection circuit 15 to specify the position or touch area of the object to be detected. The position of the object to be detected is derived by performing an operation of converting the output signal 17A into image information (for example, bitmap data) corresponding to coordinates on the pixel region 11-1, and extracting a centric coordinate (or a barycentric coordinate) through the use of the image information obtained by conversion. Moreover, in the case where a plurality of centric coordinates (or a plurality of barycentric coordinates) are derived, for example, labeling processing is performed on each of the derived centric coordinates (or barycentric coordinates). The touch area is obtained by extracting the coordinates of an outer edge through the use of the above-described image information and calculating the area of a region surrounded by the outer edge. The information derived in such a manner is outputted from the image processing section 21 to the application program execution section 22 as touch information 21A.

The application program execution section 22 executes processing based on a predetermined application program, and, for example, the application program execution section 22 superimposes predetermined data on image data 22A or replaces the image data 22A by another data based on an output (the touch information 21A) from the image processing section 21. The application program execution section 22 includes, for example, one or a plurality of processors executing a predetermined program.

In the application program execution section 22, predetermined processing starts in response to the input of the output signal 18A from the touch detection circuit 15 as a trigger. For example, while any signal is not inputted from the image processing section 21, a part (a processor) corresponding to a part executing processing in response to an output (the touch information 21A) from the image processing section 21 may sleep, and the part may wake up (restart) in response to the input of the output signal 18A from the touch detection circuit 15 as a trigger. In such a case, a reduction in power consumption is achieved.

The signal transmission section 30 transmits signals between the display section 10 and the external processing section 20, and includes, for example, a flexible printed circuit (FPC). The FPC includes, for example, a strip-shaped base film extending in one direction. A connector (not illustrated) connected to a connector (not illustrated) of the display section 10 is arranged at an end of the base film, and a connector (not illustrated) connected to a connector (not illustrated) of the external processing section 20 is arranged at the other end of the base film. Wiring (not illustrated) connected to both of the connectors arranged at both ends of the base film, respectively, is arranged on a surface of the base film. Further, in the signal transmission section 30, a cover (not illustrated) for protecting the wiring on the base film is arranged.

Next, an example of operation of the display 1 according to the embodiment will be described below.

In the display 1, a display drive signal is outputted from a display signal driver in the display control circuit 13 based on the image data 22A supplied from the application program execution section 22, and a line-sequential drive is performed by the scanner for display in the display control circuit 13 to display an image on the display surface. At this time, a light reception drive signal is outputted from a light reception driver in a light reception control circuit 14, and a line-sequential drive is performed by a scanner for light reception in the light reception control circuit 14 to pick up an image.

Then, in the touch detection circuit 15, signal processing as preprocessing for deriving information such as the position or touch area of the object to be detected is performed in response to the output signals 11C outputted from the sensor devices 11B. As a result, the output signal 17A (serial data) and the output signal 18A (the determination result) are outputted substantially simultaneously whenever each of the output signals 11C from one row of sensor devices 11B in the plurality of sensor devices 11B is inputted.

Next, the image processing section 21 starts a process of specifying the position or the touch area of the object to be detected, and almost at the same time, the application program execution section 22 starts predetermined processing in response to the input of the output signal 18A from the touch detection circuit 15 as a trigger. For example, a processor corresponding to a part executing processing in response to the output (the touch information 21A) from the image processing section 21 wakes up in response to the input of the output signal 18A from the touch detection circuit 15 as a trigger. Thereby, when the output (the touch information 21A) from the image processing section 21 is inputted, the part (the processor) corresponding to the part executing processing in response to the output (the touch information 21A) from the image processing section 21 already wakes up, so processing based on the touch information 21A is executable immediately.

Thus, in the embodiment, in the touch detection circuit 15 arranged in the I/O panel 11, the output signal 18A (the determination result) is outputted before inputting the output signals 11C from all sensor devices 11B. Thereby, for example, the output signal 18A (the determination result) is allowed to be inputted into the external processing section 20 before inputting the output signals 17A (the serial data) obtained from the output signals 11C from all sensor devices 11B into the external processing section 20 arranged separately from the I/O panel 11. As a result, for example, preprocessing such as starting predetermined processing using the output signal 18A (the determination result) in the application program execution section 22 or waking up a sleeping part (a sleeping processor) in the application program execution section 22 in response to the output signal 18A (the determination result) as a trigger is allowed to start early. Therefore, a necessary time, from when the object touches the display surface to when the execution of main arithmetic processing in a processing circuit in the following state, i.e., the application program execution section 22, starts, is allowed to be reduced by starting the preprocessing early, thereby latency is allowed to be reduced.

In the embodiment, it is not necessary to increase the scan speed for the sensor devices 11B, so it is not necessary to arrange a signal line or a scanning line for detection, thereby there is little possibility that display performance is degraded by an improvement in latency. Therefore, latency is allowed to be reduced without degradation in display performance.

### Modification

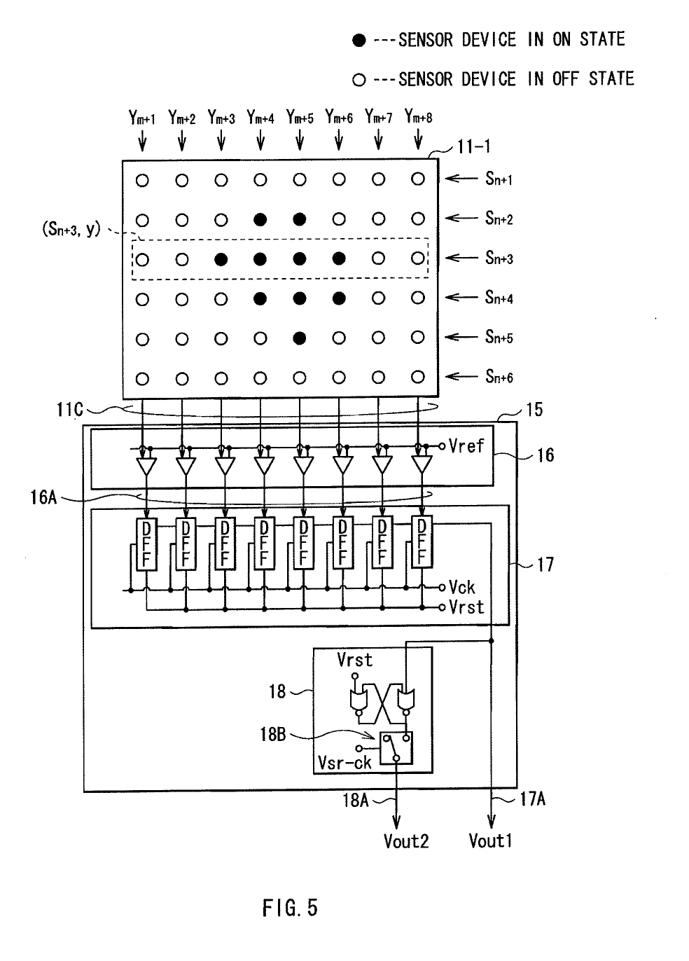

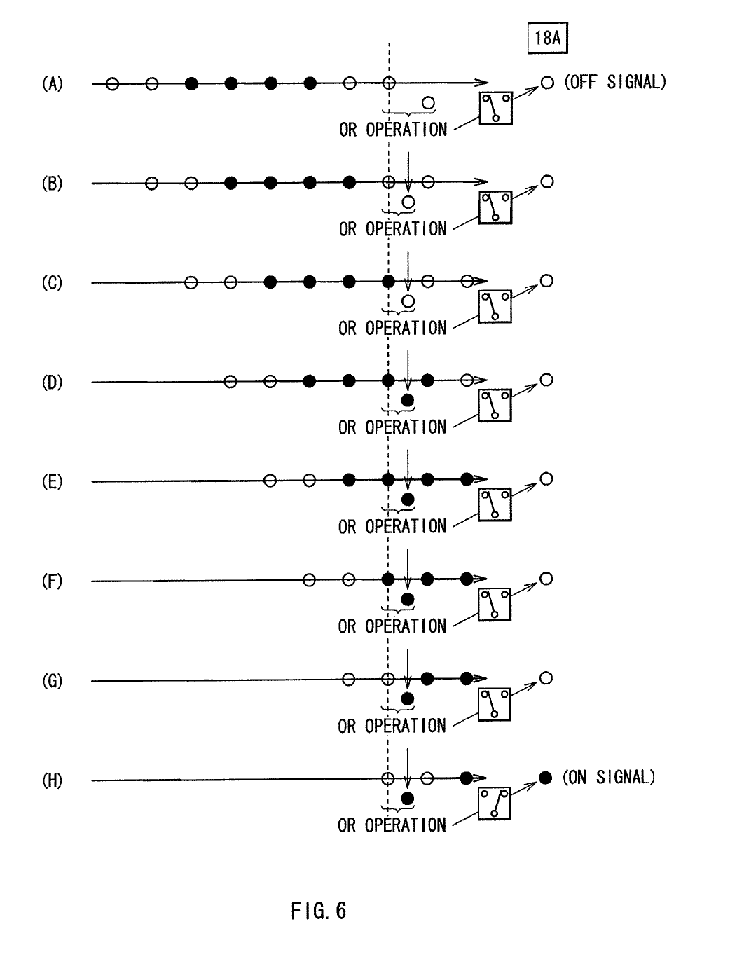

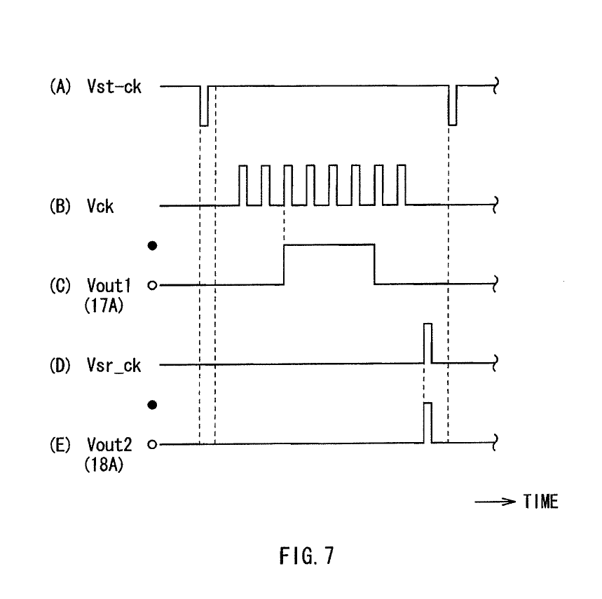

In the above-described embodiment, the touch detection circuit 15 outputs the determination result as the output signal 18A whenever each of the output signals 17A obtained from the output signals 11C from one row of sensor devices 11B in the plurality of sensor devices 11B is inputted in series. However, the determination result as the output signal 18A may be outputted at any other timing. To output the determination result as the output signal 18A at the other timing, for example, as illustrated in FIG. 5, a switch device 18B may be arranged in an output stage of the determination circuit 18. In such a case, for example, as illustrated in FIGS. 6(A) to 6(H) and FIGS. 7(A) to 7(E), all of the output signals 17A obtained from output signals 11C from all sensor devices 11B located in a row in the plurality of sensor devices 11B may be inputted, and then the switch device 18B may turn on or off the signal V_{sr-ck} applied to a clock line connected to the switch device 18B, and the determination result may be outputted as the output signal 18A in synchronization with the on/off operation of the signal V_{sr-ck}.

Moreover, in the above-described embodiment and the above-described modification, the determination circuit 18 includes the OR circuit. However, for example, the determination circuit 18 may include an AND circuit which determines whether or not both of two temporally adjacent output signals 17A in the output signals 17A sequentially inputted from the parallel-in serial-out circuit 17 correspond to ON signals.

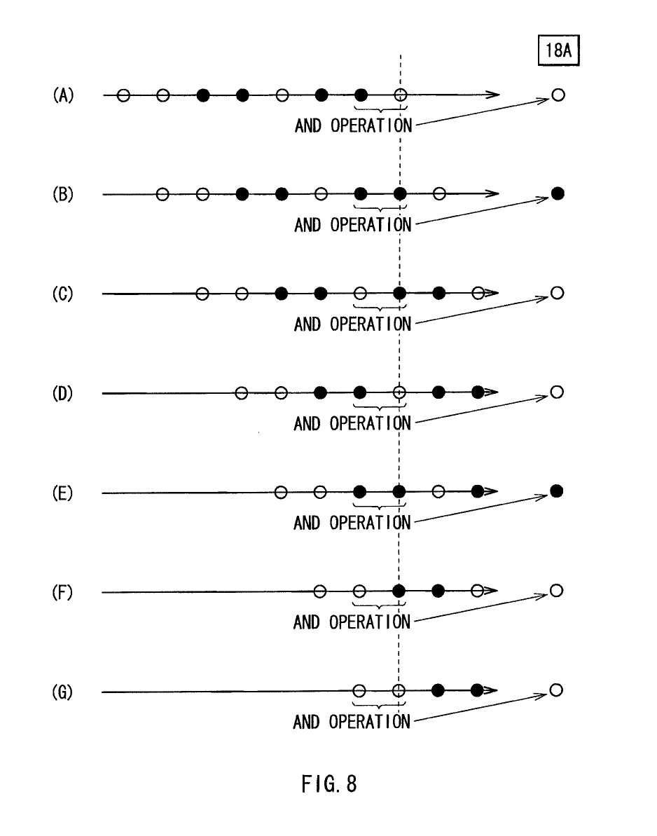

Now, a determination method with the AND circuit will be described below referring to schematic views illustrated in FIGS. 8(A) to 8(G). First, an AND operation is performed on an output signal 17A (a white circle located on a broken line in FIG. 8(A)) inputted from the rightmost sensor device 11B in a group of output signals 17A and an output signal 17A (a black circle located next to the white circle on the left on the broken line in FIG. 8(A)) inputted from the second sensor device 11B from the right in the group of output signals 17A. In this case, one of the output signals 17A corresponds to a black circle, that is, an ON signal, so the determination circuit 18 outputs a signal corresponding to an OFF signal as the output signal 18A.

Next, an AND operation is performed on the output signal 17A (a black circle located on a broken line in FIG. 8(B)) inputted from the second sensor device 11B from the right in the group of output signals 17A and an output signal 17A (a black circle located next to the black circle on the left on the broken line in FIG. 8(B)) inputted from the third sensor device 11B from the right. In this case, both of the output signals 17A correspond to black circles, that is, ON signals, so the determination circuit 18 outputs a signal corresponding to an ON signal as the output signal 18A.

The determination circuit 18 further performs AND operations as illustrated in FIGS. 8(C) to 8(G) in the same manner, and outputs a signal corresponding to a result of each AND operation as the output signal 18A.

### Second Embodiment

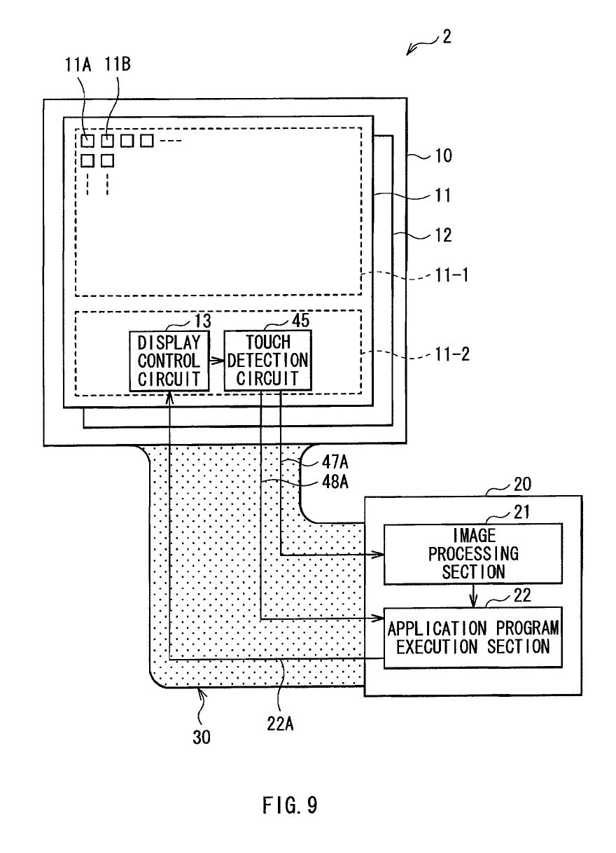

FIG. 9 illustrates the whole configuration of a display 2 according to a second embodiment of the invention. The configuration of the display 2 is distinguished from the configuration of the display 1 including the touch detection circuit 15 in the display section 10 by the fact that the display 2 includes a touch detection circuit 45 in the display section 10. Therefore, differences from the first embodiment will be mainly described below, and similarities to the first embodiment will not be described.

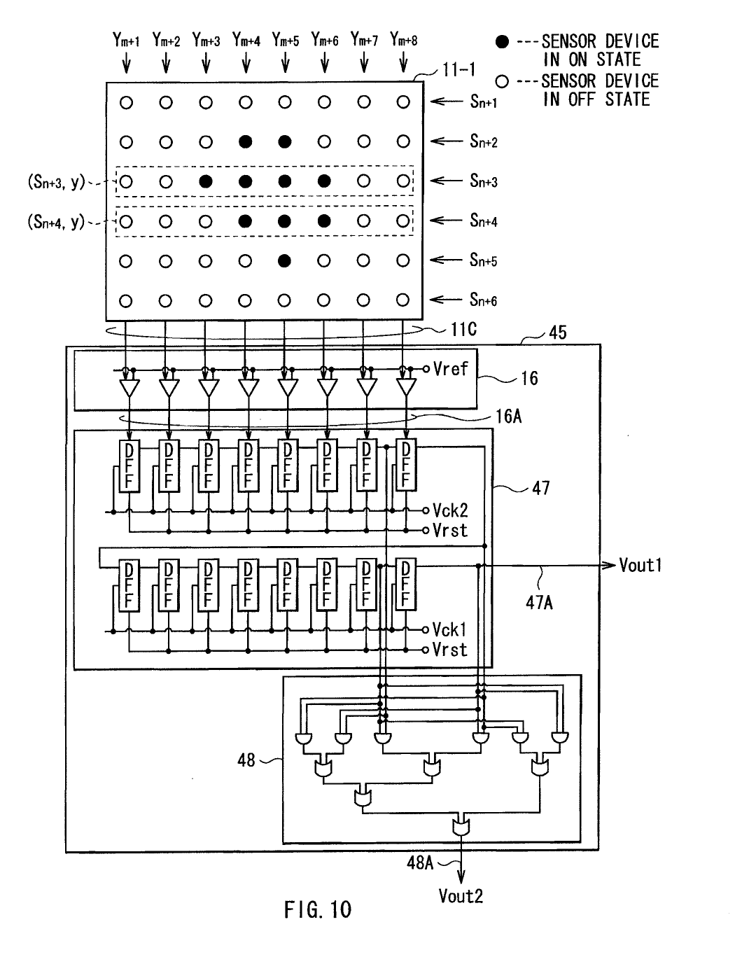

For example, as illustrated in FIG. 10, the touch detection circuit 45 includes the conversion circuit 16, a parallel-in serial-out circuit 47 and a determination circuit 48.

The parallel-in serial-out circuit 47 is a circuit converting output signals 16A outputted in parallel from the conversion circuit 16 into serial signals (serial data), and outputs the serial data as in the case of the parallel-in serial-out circuit 17 in the first embodiment. However, the parallel-in serial-out circuit 47 is allowed to output 2×2 matrices of output signals 47A obtained from output signals 11C from two adjacent rows of sensor devices 11B in the plurality of sensor device 11B to the determination circuit 48 following the parallel-in serial-out circuit 47.

More specifically, the parallel-in serial-out circuit 47 includes, in the following stage of the parallel-in serial-out circuit 17 in the first embodiment, the same number of 1-input/1-output DFFs as the 2-input/2-output DFFs included in the parallel-in serial-out circuit 17. The 1-input/1-output DFFs are connected to one another in series. Moreover, output terminals of the last DFF and the second last DFF located at the former stage of the parallel-in serial-out circuit 47 and output terminals of the last DFF and the second last DFF located at the latter stage of the parallel-in serial-out circuit 47 are output terminals of the parallel-in serial-out circuit 47. Then, these four output terminals are connected to four input terminals of the determination circuit 48, respectively. Further, the output terminal of the last DFF located at the latter stage of the parallel-in serial-out circuit 47 is one of output terminals of the touch detection circuit 45, and is connected to an input terminal of the image processing section 21 through the signal transmission section 30.

In addition, a common clock line (V_{ckl}) is connected to a clock terminal of each 2-input/2-output DFF located at the former stage of the parallel-in serial-out circuit 47, and a common clock line (V_{ck2}) is connected to a clock terminal of each 1-input/1-output DFF. Moreover, as in the case of the 2-input/2-output DFFs located at the former stage of the parallel-in serial-out circuit 47, a common reset line (Vᵣₛₜ) is connected to a reset terminal of each 1-input/1-output DFF.

The determination circuit 48 determines whether or not an output signal corresponding to an ON signal is included in 2×2 matrices of output signals 47A sequentially inputted from the parallel-in serial-out circuit 47. For example, as illustrated in FIG. 10, the determination circuit 48 includes a circuit which determines whether or not both of two adjacent output signals 47A in each of 2×2 matrices of output signals 47A sequentially inputted from the parallel-in serial-out circuit 47 correspond to the ON signals. In addition, in FIG. 10, a configuration example of a circuit which determines whether or not both of two obliquely adjacent output signals 47A in a 2×2 matrix of output signals 47A correspond to the ON signals is illustrated, but if necessary, a circuit part used for determination of obliquely adjacent output signals 47A in a 2×2 matrix of output signals 47A may be removed.

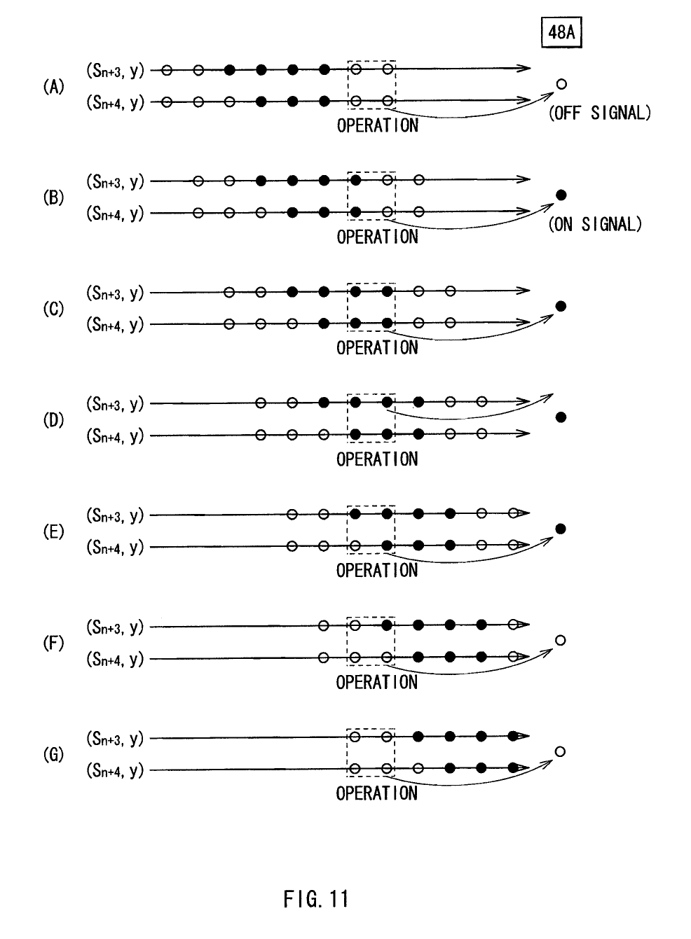

A determination method with the above-described circuit will be described referring to schematic views illustrated in FIGS. 11(A) to 11(G). First, the above-described operation is performed on output signals 47A (two white circles located on the right in a square drawn with a broken line in FIG. 11(A)) inputted from the rightmost sensor devices 11B in a group of output signals 47A (for example, output signals 47A located in rows (Sₙ₊₃, y) and (Sₙ₊₄, y) in FIG. 10), and output signals 47A (two white circles located on the left in the square drawn with the broken line in FIG. 11(A)) inputted from the second sensor devices 11B from the right in the group of output signals 47A (for example, the output signals 47A located in the rows (Sₙ₊₃, y) and (Sₙ₊₄, y) in FIG. 10). In this case, the four output signals 47A correspond to white circles, that is, OFF signals, so the determination circuit 48 outputs a signal corresponding to an OFF signal as an output signal 48A.

Next, the above-described operation is performed on output signals 47A (two white circles located on the right in a square drawn with a broken line in FIG. 11(B)) inputted from the second sensor devices 11B from the right in the group of output signals 47A (for examples, the output signals 47A located in the rows (Sₙ₊₃, y) and (Sₙ₊₄, y) in FIG. 10), and output signals 47A (two black circles located on the left in the square drawn with the broken line in FIG. 11(B)) inputted from the third sensor devices 11B from the right in the group of output signals 47A (for example, the output signals 47A in the rows (Sₙ₊₃, y) and (Sₙ₊₄, y) in FIG. 10). In this case, the two output signals 47A on the left correspond to black circles, that is, ON signals, so the determination circuit 48 outputs a signal corresponding to an ON signal as the output signal 48A.

As illustrated in FIGS. 11(C) and 11(G), the determination circuit 48 further performs the above-described operations in the same manner, and outputs a signal corresponding to a result of each operation as the output signal 48A.

Thus, the touch detection circuit 45, prior to taking all of the output signals from the plurality of sensor devices 11B, determines whether or not the ON signal is included in previously inputted output signals 11C, and outputs a determination result as the output signal 48A. Moreover, the touch detection circuit 45 outputs a determination result as the output signal 48A whenever each of 2×2 matrices of output signals 47A obtained from the output signals 11C from two rows of sensor devices 11B in the plurality of sensor devices 11B is inputted.

As in the case of the first embodiment, the external processing section 20 includes the image processing section 21 and the application program execution section 22. The image processing section 21 performs predetermined signal processing on the output signals 47A (serial data) inputted from the touch detection circuit 45 to specify the position or touch area of an object (an object to be detected) which touches or comes close to the display surface. Moreover, in the application program execution section 22, predetermined processing starts in response to the input of the output signal 48A from the touch detection circuit 45 as a trigger. For example, while any signal is not inputted from the image processing section 21, a processor corresponding to a part executing processing in response to an output (touch information 21A) from the image processing section 21 may sleep, and the processor may wake up (restart) in response to the input of the output signal 48A from the touch detection circuit 45 as a trigger.

Next, an example of operation of the display 2 according to the embodiment will be described below.

In the display 2, a display drive signal is outputted from a display signal driver in the display control circuit 13 based on the image data 22A supplied from the application program execution section 22, and a line-sequential drive is performed by the scanner for display in the display control circuit 13 to display an image on the display surface. At this time, a light reception drive signal is outputted from the light reception driver in the light reception control circuit 14, and a line-sequential drive is performed by the light reception scanner in the light reception control circuit 14 to pick up an image.

Then, in the touch detection circuit 45, signal processing as preprocessing for deriving information such as the position or touch area of the object to be detected is performed in response to the output signals 11C outputted from the sensor devices 11B. As a result, the output signal 47A (serial data) and the output signal 48A (the determination result) are outputted substantially simultaneously whenever each of 2×2 matrices of output signals 47A obtained from the output signals 11C from two rows of sensor devices 11B in the plurality of sensor devices 11B is inputted.

Next, the image processing section 21 starts a process of specifying the position or the touch area of the object to be detected, and almost at the same time, the application program execution section 22 starts predetermined processing in response to the input of the output signal 48A from the touch detection circuit 45 as a trigger. For example, a processor corresponding to a part executing processing in response to the output (the touch information 21A) from the image processing section 21 wakes up in response to the input of the output signal 48A from the touch detection circuit 45 as a trigger. Thereby, when the output (the touch information 21A) from the image processing section 21 is inputted, the processor corresponding to the part executing processing in response to the output (the touch information 21A) from the image processing section 21 already wakes up, so processing based on the touch information 21A is executable immediately.

Thus, in the embodiment, in the touch detection circuit 15 arranged in the I/O panel 11, the output signal 48A (the determination result) is outputted before inputting the output signals 11C from all sensor devices 11B. Thereby, for example, the output signal 48A (the determination result) is allowed to be inputted into the external processing section 20 before inputting the output signals 47A (the serial data) obtained from the output signals 11C from all sensor devices 11B into the external processing section 20 arranged separately from the I/O panel 11. As a result, for example, preprocessing such as starting predetermined processing using the output signal 48A (the determination result) in the application program execution section 22, or waking up a sleeping part in the application program execution section 22 in response to the output signal 48A (the determination result) as a trigger is allowed to start early. Therefore, a necessary time, from when the object touches the display surface to when the execution of main arithmetic processing in a processing circuit in the following state, i.e., the application program execution section 22, starts, is allowed to be reduced by starting the preprocessing early, thereby latency is allowed to be reduced.

In addition, also in the embodiment, it is not necessary to increase the scan speed for the sensor devices 11B, so it is not necessary to arrange a signal line or a scanning line for detection, and there is little possibility that display performance is degraded by an improvement in latency. Therefore, latency is allowed to be reduced without degradation in display performance.

### Modification

In the second embodiment, the parallel-in serial-out circuit 47 outputs 2×2 matrices of output signal 47A obtained from the output signals 11C from two adjacent rows of sensor devices 11B in the plurality of sensor devices 11B to the determination circuit 48. However, the parallel-in serial-out circuit 47 may output 3×3 matrices of output signals 47A to the determination circuit 48. However, in this case, the determination circuit 48 preferably includes, for example, a circuit which determines whether or not all of three adjacent output signals 47A in each of 3×3 matrices of output signals 47A sequentially inputted from the parallel-in serial-out circuit 47 correspond to ON signals.

Although the present invention is described referring to the embodiments and the modifications, the invention is not limited thereto, and may be variously modified.

For example, in the above-described embodiments and the like, only determination information is extracted as element information in the touch detection circuit 15. However, any other information is allowed to be extracted in the touch detection circuit 15.

For example, information on the number of output signals 11C corresponding to ON signals included in a set of output signals 11C from one or more rows of sensor devices 11B in the plurality of sensor devices 11B may be extracted in the touch detection circuit 15. Moreover, as the element information, for example, information on the position of a sensor device 11B outputting the output signal 11C corresponding to the ON signal included in a set of the output signals 11C from one or more rows of sensor devices 11B in the plurality of sensor devices 11B may be extracted in the touch detection circuit 15. In addition, the latter information may include, for example, the position (the start point) of the sensor device 11B outputting an output signal 11C first detected as an output signal corresponding to the ON signal in a group of output signals 11C, the position (an end point) of the sensor device 11B outputting an output signal 11C detected as the output signal corresponding to the ON signal previous to an output signal 11C detected as an output signal corresponding to the OFF signal (an output signal not affected by the object to be detected) after the start point is detected, a distance between the start point and the end point (a width between both ends), and the like. In addition, image information (for example, bitmap data) in which the output signal 17A correspond to coordinates on the pixel region 11-1 may be reconstructed by using information on the number of ON signals, information on the start point or the end point, and information on the width between both ends.

Moreover, in the above-described embodiments and the like, the case where the sensor devices 11B are contact type sensors is described, but the sensor devices 11B may be light reception type sensors such as photodiodes. In this case, the object is detectable not only in the case where the object touches a surface but also in the case where the object comes close to the surface, and, for example, information on a fingerprint or veins of a finger touching the surface may be read out. In addition, in the case where the sensor devices 11B are light reception type sensors, a light reception control circuit (not illustrated) controlling the sensor devices 11B is preferably arranged in the pixel region 11-1.

Further, in the above-described embodiments, the case where the display section 10 includes the I/O panel 11 including the liquid crystal display panel on the backlight 12 is described. However, the display section 10 may include a self-luminous panel in which a display element forming a pixel emits light, such as an organic EL panel including an organic layer between transparent substrates opposed to each other.

Moreover, the input/output device or the like described above is applicable to electronic devices in every field which display image signals inputted from outside or image signals produced inside as an image or motion pictures such as televisions, digital cameras, notebook personal computer, mobile devices such as cellular phones, video cameras and the like.

In the input device and the display according to the above-described embodiments, in the processing circuit arranged in the panel, prior to taking in all of output signals from all of sensor devices, determination information is outputted, so before signals obtained from the output signals from all of the sensor devices are inputted into the external processing section provided separately from the panel, for example, preprocessing such as starting arithmetic processing using the above-described determination information in the external processing section, or restarting (waking up) the external processing section in a sleeping state is allowed to start early. Thereby, latency is allowed to be reduced. Moreover, in the above-described embodiments, it is not necessary to arrange a signal line or a scanning line for detection, so there is little possibility that display performance is degraded by an improvement in latency.

The present application contains subject matter related to that disclosed in Japanese Priority Patent Application JP 2008-256060 filed in the Japan Patent Office on Oct. 1, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

1. An input device comprising a panel including:
a plurality of sensor devices two-dimensionally arranged in row and column directions,
a drive circuit driving the plurality of sensor devices, and
a processing circuit processing output signals from the plurality of sensor devices,
wherein the processing circuit, prior to taking in all of the output signals from the plurality of sensor devices, determines whether or not one or more ON signals, defined as output signals affected by an object which touches or comes close to a surface of the panel, are included in previously inputted output signals, and then outputs a determination result.

2. The input device according to claim 1, wherein
the processing circuit outputs the determination result whenever each of the output signals from one or more rows of sensor devices is inputted.

3. The input device according to claim 1, wherein
the processing circuit outputs the determination result after a set of output signals from one or more rows of sensor devices are inputted.

4. The input device according to claim 1, further comprising:
an external processing section provided separately from the panel; and
a signal transmission section transmitting signals between the panel and the external processing section,
wherein the processing circuit outputs the determination result to the external processing section.

5. The input device according to claim 1, wherein
the processing circuit counts number of the ON signals included in a set of output signals from one or more rows of sensor devices in the plurality of sensor devices, and extracts the positions of the ON signals, and then outputs information on the number of the ON signals and the positions of the ON signals.

6. An input device comprising a panel including:
a plurality of sensor devices two-dimensionally arranged in row and column directions, and
a processing circuit processing output signals from the plurality of sensor devices,
wherein the processing circuit, prior to completion of taking in the output signals from the plurality of sensor devices, determines whether or not one or more ON signals, defined as output signals representing detection of an object which touches or comes close to a surface of the panel, are included in previously inputted output signals, and then outputs a determination result.

7. The input device according to claim 6, wherein
the processing circuit outputs the determination result as well as a serial signal obtained by converting the output signals from the plurality of sensor devices into serial data.

8. The input device according to claim 7, wherein
the processing circuit outputs the determination result whenever each of the output signals from one or more rows of sensor devices is inputted.

9. The input device according to claim 7, wherein
the processing circuit outputs the determination result after the input of a set of output signals from one or more rows of sensor devices is completed.

10. The input device according to claim 6, further comprising:
an external processing section provided separately from the panel; and
a signal transmission section transmitting signals between the panel and the external processing section,
wherein the processing circuit outputs the determination result to the external processing section.

11. The input device according to claim 6, wherein the processing circuit counts number of the ON signals included in a set of output signals from one or more rows of sensor devices in the plurality of sensor devices, and extracts positions of the ON signals, and then outputs information on the number of the ON signals and the positions of the ON signals.

12. A display comprising a panel including:
a plurality of display pixels and a plurality of sensor devices two-dimensionally arranged in row and column directions,
a drive circuit driving the plurality of display pixels and the plurality of sensor devices, and
a processing circuit processing output signals from the plurality of sensor devices,
wherein the processing circuit, prior to taking in all of the output signals from the plurality of sensor devices, determines whether or not one or more ON signals, defined as output signals affected by an object which touches or comes close to a surface of the panel, are included in previously inputted output signals, and then outputs a determination result.

13. A display comprising a panel including:
a plurality of display pixels and a plurality of sensor devices two-dimensionally arranged in row and column directions,
a drive circuit scanning and driving the plurality of display pixels and the plurality of sensor devices, and
a processing circuit processing output signals from the plurality of sensor devices,
wherein the processing circuit, prior to completion of taking in the output signals from the plurality of sensor devices, that are obtained by scanning of the drive circuit at each predetermined period, determines whether or not one or more ON signals, defined as output signals representing detection of an object which touches or comes close to a surface of the panel, are included in previously inputted output signals, and then outputs a determination result.
